(19) United States
(12) Patent Application Publication
(10) Pub. No.: US 2003/0035052 A1
(43) Pub. Date: Feb. 20, 2003

(54) User selection device for camera navigation

(76) Inventor: John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 09/933,533

(22) Filed: Aug. 20, 2001

(51) Int. Cl. H04N 5/225

(52) U.S. Cl. 348/207.99; D16/200

(57) ABSTRACT

An image capturing device includes a body including a lens barrel and a two-axis user selection device affixed to the lens barrel. The user selection device includes a contact surface and a center positional detent. An included horizontal displacement sensor is capable of generating an electronic signal related to a horizontal displacement of the user selection device and an included vertical displacement sensor is capable of generating an electronic signal related to a vertical displacement. An included depression sensor is capable of generating a select signal when the user selection device is depressed.

### FIELD OF THE INVENTION

The present invention relates generally to a user selection device, and more particularly to a user selection device for camera navigation.

### BACKGROUND OF THE INVENTION

Image capturing devices, such as cameras, are widely used to memorialize scenes, events, occasions, etc. Most image capturing devices, including analog and digital still cameras and analog or digital video cameras, may include multiple modes and multiple operational options. For example, a typical still camera may include options for a flash setting, an exposure level, a picture quality, a date stamp, etc. Consequently, a still or video camera may include some manner of display screen upon which may be displayed a menu, list, etc., that displays mode options that may be selected by the user. The camera therefore may include some manner of selection interface, including input buttons, up/down rocker buttons, or a four-way rocker switch with a center depress action.

In the prior art, in order to select items from the displayed menu or list, the user had to manipulate the up/down buttons or rocker switch to highlight a particular displayed item, for example. The user then had to lift his or her finger and press a separate button that selects highlighted items or, in the case of a four-way rocker switch, depress a center area in order to perform the selection. This was generally done at the back of the camera.

The prior art camera device has several drawbacks. The user may have to press more than one button in order to manipulate the display and make a selection. This takes more attention and more time of the user. In addition, the user selection devices are typically on the back of the camera. This may be very inconvenient when the user is in a hurry, such as when the user is trying to capture an image. In the prior art, therefore, the user must generally change hand positions and hold the image capturing device out away from himself or herself in order to view a screen, manipulate input devices, and make a selection.

Therefore, there remains a need in the art for improvements in user selection devices in camera equipment.

### SUMMARY OF THE INVENTION

An image capturing device comprises a body including a lens barrel and a two-axis user selection device affixed to the lens barrel. The user selection device includes a contact surface and a center positional detent. An included horizontal displacement sensor is capable of generating an electronic signal related to a horizontal displacement of the user selection device and an included vertical displacement sensor is capable of generating an electronic signal related to a vertical displacement. An included depression sensor is capable of generating a select signal when the user selection device is depressed.

### BRIEF DESCRIPTION OF THE DRAWINGS

FIG. 1 shows an image capturing device according to one embodiment of the invention;

FIG. 2 shows a display that includes a plurality of mode variables, such as menu headings;

FIG. 3 shows a sensor arrangement;

FIG. 4 shows a four-way rocker switch according to another embodiment of the invention; and

FIG. 5 is a flowchart of a selection input method for an image capturing device according to one embodiment of the invention.

### DETAILED DESCRIPTION

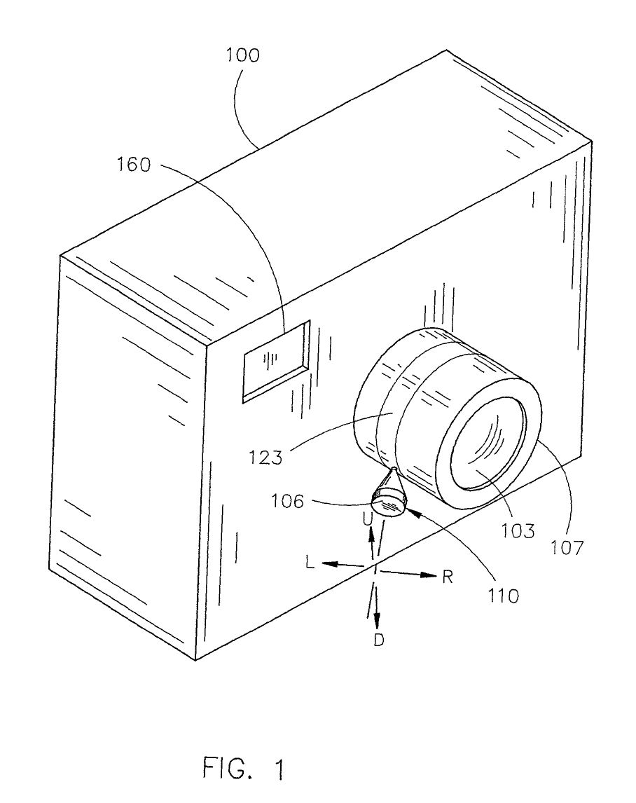

FIG. 1 shows an image capturing device 100 according to one embodiment of the invention. The image capturing device 100 may be an analog or digital still camera or an analog or digital video camera, for example. The image capturing device 100 includes a lens 103, a lens barrel 107, a lens ring 123, a view finder 160, and a user selection device 110.

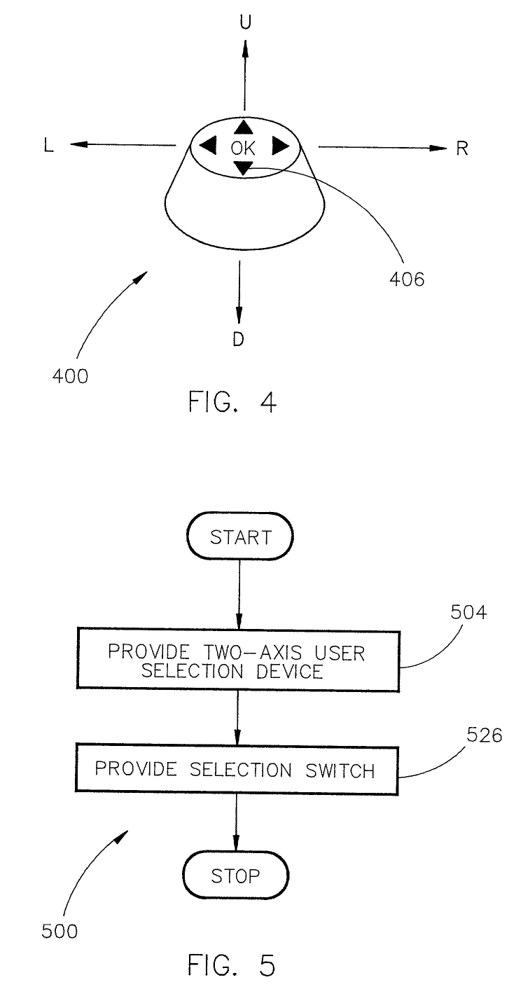

The user selection device 110 may be a finger joystick (shown) or a four-way rocker switch (see FIG. 4 and accompanying text). The user selection device 110 is a two-axis device capable of moving left and right, up and down, and combinations thereof. The user selection device 110 further includes a contact surface 106. The contact surface 106 may be concave in order to retain the user's finger when the user is manipulating the user selection device 110. In addition, the user selection device 110 may include sensors (see FIG. 3 and accompanying text) that translate physical motion of the user selection device 110 into electrical signals. The user can move the user selection device 110 in order to correspondingly move a cursor or other selection indicia on a display.

The selection indicia may be, for example, a cursor. Alternatively, the selection indicia may comprise highlighting of a mode variable, a frame superimposed on or around the mode variable, etc. For the purpose of clarity, the discussion hereafter will refer only to a cursor. The selection indicia therefore indicates which menu item or list entry is currently under consideration by the user. The pressing of a selection button may activate the variable. For example, the user may be able to find a particular mode entry for flash and select a desired flash mode.

The user selection device 110 may be used with a conventional display screen (not shown) located on the back of the image capturing device 100 or may be used with a display generated in the view finder 160. The user may move a cursor, crosshairs, etc., in the viewfinder using the user selection device 110. A display located in the viewfinder 160 may have the same capabilities of the camera back LCD display but with greatly reduced power consumption. Removing the LCD display from the back of the image capturing device 100 saves cost, power and surface area.

In one embodiment, the user selection device 110 is mounted onto the lens ring 123, with the lens ring 123 being capable of rotating on the lens barrel 107. In this embodiment, the user may position the user selection device 110 at a desired circumferential location on the lens barrel 107. Therefore, the user selection device 110 is adaptable to different hand positions and may accommodate persons that are either right-handed or left-handed. In addition, the user may manipulate mode options for the image capturing device 100 without moving his or her hands from an image capturing position (i.e., the user's fingers are at the front of the camera, not at the back side).

According to an optional feature, the lens ring 123 may include a restraining or locking mechanism (not shown) wherein the user can restrain or lock the lens ring 123 in a desired rotational position. The locking mechanism may be a friction lock, for example, or a cam lock. Alternatively, the lens ring 123 may include a plurality of detents, wherein the lens ring 123 may be restrained in one of a plurality of predetermined positions by the plurality of detents.

Alternatively, in another embodiment, the user selection device 110 may be fixedly mounted to the lens barrel 107 and may not be moved.

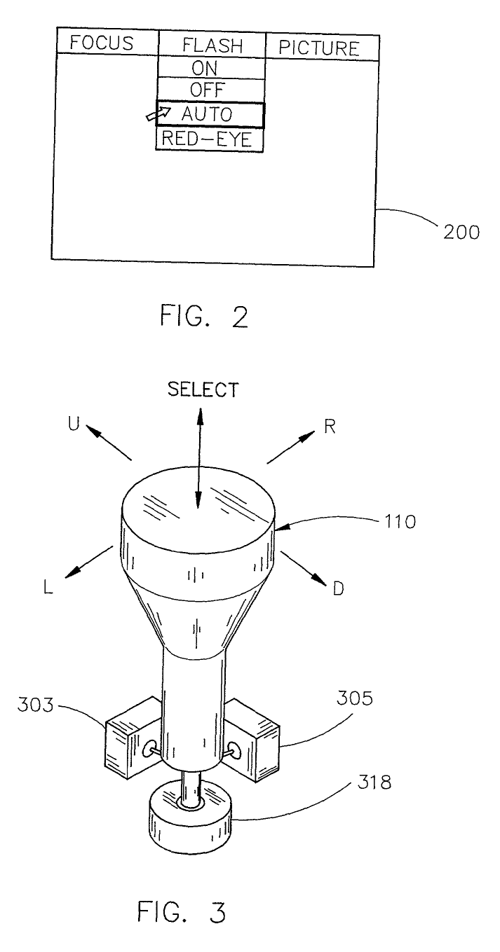

FIG. 2 shows a display 200 that includes a plurality of mode variables, such as menu headings. Each mode variable may include a variety of settings that may be chosen by the user. The user selection device 110 may move the cursor to indicate which item the user wants to select for a particular mode variable. The user may then depress the user selection device 110 in order to activate or load that value. In the example, the user has chosen an auto flash setting for the flash mode.

FIG. 3 shows a sensor arrangement. The user selection device 110 preferably contains a horizontal displacement sensor 303, a vertical displacement sensor 305, and a depression sensor 318. The horizontal displacement sensor 303 detects a horizontal (left-right) displacement of the user selection device 110. The vertical displacement sensor 305 detects a vertical (up-down) displacement of the user selection device 110.

The user selection device 110 further includes a center detent position to which the user selection device 110 normally returns when released by the user. When in the centered detent position, no action is taken by the user selection device 110 and the cursor is not moved.

In one embodiment, the horizontal and vertical displacement sensors 303 and 305 are potentiometers which receive a reference voltage and generate analog output voltages that are substantially related to the horizontal and vertical displacements of the user selection device 110. The analog voltages may be used by a control circuitry or processor (not shown) to detect the horizontal and vertical positions of the user selection device 110. The displacement amount may optionally affect a movement speed of the cursor.

Alternatively, the horizontal and vertical displacement sensors 303 and 305 may be switches, such as rocker switches, etc. The switches generate a displacement signal upon displacement of the user selection device 110, which may be interpreted by a processor or control circuitry to indicate that the user selection device 110 has been displaced. Therefore, the cursor or other user selection device may be moved incrementally, depending on how long the user selection device 110 is displaced from a centered detent position.

The depression sensor 318 senses a depression of the user selection device 110. The depression sensor 318 may be any type of momentary contact switch that opens or closes a circuit when the user selection device 110 is depressed by the user.

FIG. 4 shows a four-way rocker switch 400 according to another embodiment of the invention. The rocker switch 400 may be used instead of the finger joystick 100. The rocker switch 400 may include the features of the finger joystick 100 (i.e., it senses left/right and up/down displacement and depression), but with a lower profile. The rocker switch 400 may include arrows 406 or other indicia that visually illustrate the possible motion of the rocker switch 400. In addition, the rocker switch 400 may include an “OK” or “SELECT” indicia in the center of the rocker switch 400, indicating to the user that the rocker switch 400 may be depressed in order to perform a selection action.

FIG. 5 is a flowchart 500 of a selection input method for an image capturing device 100 according to one embodiment of the invention. In step 504, a user selection device 110, such as a joystick or four-way rocker switch, is provided on the image capturing device 100. The user selection device 110 may be mounted to the lens barrel 107. Alternatively, a rotatable lens ring 123 my be provided on the lens barrel 107, and the user selection device 110 may be affixed to the lens ring 123. The lens ring 123 allows the user selection device 110 to be rotationally positioned by a user.

In step 526, a selection switch is provided on the user selection device 110, allowing the user selection device 110 to be depressed in order to select a currently indicated or highlighted mode variable.

The invention provides several benefits to the user of an image capturing device 100. The user can use one input device to select a menu or list item. The user does not have to move his or her fingers, or take an eye away from the viewfinder in order to change mode variables. The user selection device 110 according to the invention therefore requires less attention and the user can keep an eye to the viewfinder 160. The user does not have to look away from the viewfinder 160 in order to navigate a menu and make a mode variable selection. Furthermore, because the user selection device 110 is located on the lens barrel 107, the user may manipulate camera options without moving his or her hands from a picture taking position. Moreover, the user can position the user selection device 110 where it is most convenient and can reposition the user selection device depending on his or her preference.

We claim:

1. An image capturing device, comprising:
a body including a lens barrel;
a two-axis user selection device affixed to said lens barrel, said user selection device being displaceable along axes in orthogonal directions and being movable in a direction toward said lens barrel by a depressing operation;
a horizontal displacement sensor capable of generating an electronic signal related to a horizontal displacement of said user selection device;
a vertical displacement sensor capable of generating an electronic signal related to a vertical displacement of said user selection device; and
a depression sensor capable of generating a select signal when said user selection device is depressed.

2. The image capturing device of claim 1, wherein said user selection device comprises a finger joystick.

3. The image capturing device of claim 1, wherein said user selection device comprises a four-way rocker switch.

4. The image capturing device of claim 1, wherein said horizontal and vertical displacement sensors comprise rocker switches.

5. The image capturing device of claim 1, wherein said horizontal and vertical displacement sensors comprise potentiometers.

6. The image capturing device of claim 1, wherein said user selection device is located on said lens barrel at a region contacted by a user holding said image capturing device.

7. The image capturing device of claim 1, further comprising a lens ring rotatably mounted onto said lens barrel, said user selection device is affixed to said lens ring, and wherein said lens ring is capable of being rotationally positioned by a user.

8. The image capturing device of claim 1, further comprising:
a lens ring rotatably mounted onto said lens barrel and said user selection device is affixed to said lens ring; and
a lens ring restraining device, said lens ring restraining device being selected from the group consisting of a friction lock, a cam lock, and a plurality of detents.

9. An image capturing device, comprising:
a body including a lens barrel;
a lens ring rotatably mounted onto said lens barrel;
a two-axis user selection device affixed to said lens ring, said user selection device being displaceable along axes in orthogonal directions and being movable in a direction toward said lens barrel by a depressing operation;
a horizontal displacement sensor capable of generating an electronic signal related to a horizontal displacement of said user selection device;
a vertical displacement sensor capable of generating an electronic signal related to a vertical displacement of said user selection device; and
a depression sensor capable of generating a select signal when said user selection device is depressed;
wherein said lens ring is capable of being rotationally positioned by a user.

10. The image capturing device of claim 9, wherein said lens ring further comprises a friction lock capable of retaining said lens ring in a fixed rotational position on said lens barrel.

11. The image capturing device of claim 9, wherein said lens ring further comprises a cam lock capable of retaining said lens ring in a fixed rotational position on said lens barrel.

12. The image capturing device of claim 9, wherein said lens ring further comprises a plurality of detents capable of restraining said lens ring in one of a plurality of predetermined positions by said plurality of detents.

13. The image capturing device of claim 9, wherein said user selection device comprises a finger joystick.

14. The image capturing device of claim 9, wherein said user selection device comprises a four-way rocker switch.

15. The image capturing device of claim 9, wherein said horizontal and vertical displacement sensors comprise rocker switches.

16. The image capturing device of claim 9, wherein said horizontal and vertical displacement sensors comprise potentiometers.

17. The image capturing device of claim 9, wherein said user selection device is located on said lens barrel at a region contacted by a user holding said image capturing device.

18. A selection input method for an image capturing device, comprising the steps of:
providing a two-axis user selection device on a lens barrel of said image capturing device, said user selection device generating a horizontal displacement signal related to a horizontal displacement of said user selection device and a vertical displacement signal related to a vertical displacement; and
providing a selection switch that detects a depression of said user selection device and generates a select signal when said user selection device is depressed.

19. The method of claim 18, further comprising the steps of:
providing a lens ring on said lens barrel, said lens ring being capable of rotating on said lens barrel; and
affixing said user selection device to said lens ring;
wherein said lens ring is capable of being rotationally positioned by a user.

20. The method of claim 19, further comprising the step of providing a lens ring restraining device capable of restraining a rotation of said lens ring on said lens barrel.
